(19) United States
(12) Patent Application Publication
(10) Pub. No.: US 2006/0148944 A1
(43) Pub. Date: Jul. 6, 2006

(54) Hardenable mixtures, method for the production thereof, and use of the same

(75) Inventors: Hubert Baumgart, Munster (DE); Annette Roters, Munster (DE)

Correspondence Address: BASF CORPORATION, 1609 BIDDLE AVENUE, WYANDOTTE, MI, 48192, US

(73) Assignee: BASF Coatings Aktiengesellschaft, ,, Munster (DE)

(21) Appl. No.: 10/542,207

(22) PCT Filed: Jan. 14, 2004
(86) PCT No.: PCT/EP04/00180

§ 371 Date: Jul. 14, 2005

(30) Foreign Application Priority Data
Feb. 3, 2003 (DE) 103 04 127.3

(51) Int. Cl. C08K 5/16

(52) U.S. Cl. 524/186

(57) ABSTRACT

Curable compositions comprising: (A) at least one constituent curable physically or thermally and/or with actinic radiation, (B) at least one kind of inorganic nanoparticles having an electrophoretic mobility μe≦−0.5 (μm/s)/(V/cm) at a pH of 3 to 7, and
(C) at least one light stabilizer based on sterically hindered amines (HALS) having a pK_{b} of at least 9.0; process for preparing them, and their use.

### FIELD OF THE INVENTION

The present invention relates to novel curable compositions. The present invention also relates to a novel process for preparing curable compositions. The present invention further relates to the use of the novel curable compositions and of the curable compositions prepared by the novel process for producing scratch-resistant self-supporting films and scratch-resistant moldings and also as coating materials, adhesives, and sealants for producing scratch-resistant coatings, adhesive films, and seals, especially as coating materials for producing clear; transparent, scratch-resistant coatings.

### PRIOR ART

Curable compositions suitable as coating materials for producing scratch-resistant coatings are known. Familiarly, they comprise nanoparticles and constituents curable thermally and/or with actinic radiation (cf. international patent applications WO 96/34905 A1, WO 00/75244 A1 and WO 01/09231 A1, and American patent U.S. Pat. No. 5,384,367 A1). Where the known coating materials serve to produce scratch-resistant coatings, especially clear, transparent, scratch-resistant coatings for vehicles, particularly automobiles, they must comprise light stabilizers, especially sterically hindered amines (HALS), in order to ensure their long-term stability under normal operating conditions.

The inorganic nature of the nanoparticles which impart scratch resistance causes considerable problems, which are manifested in particular in the case of the coating materials which serve to produce clear, transparent, scratch-resistant coatings, especially clearcoats. For instance, a frequent occurrence owing to the fundamental incompatibility between the originally hydrophilic, inorganic nanoparticles and the other, predominantly organic constituents of the coating materials is a separation, which even in the coating materials in question leads to such severe turbidity, going as far as complete gelling or coagulation, that they can no longer be used to produce clearcoats. Moreover, the storage of the coating materials may be accompanied by a sharp rise in their viscosity.

Here and below, the property of being “hydrophilic” refers to the constitutional property of a molecule, functional group or particle to penetrate the aqueous phase or to remain therein. Accordingly, the property of being “hydrophobic” refers to the constitutional property of a molecule, functional group or particle to behave exophilically with respect to water, i.e., to tend not to penetrate into water, or to depart the aqueous phase. For further details refer to Römpp Lexikon Lacke and Druckfarben, Georg Thieme Verlag, Stuttgart, N.Y., 1998, “hydrophilicity”, “hydrophobicity”, pages 294 and 295.

In order to avoid these serious problems, a measure taken in the prior art is complex modification of the surface of the nanoparticles.

Thus, international patent application WO 00/75244 A proposes reacting carboxyl-functionalized nanoparticles with epoxy-functional binders in order to eliminate or substantially avoid the compatibility problems in coating systems comprising nanoparticles.

American patent U.S. Pat. No. 5,384,367 A1 or international patent application WO 96/34905 A proposes the use of modified Aerosil® R812 from Degussa as nanoparticles. This product is produced by subjecting Aerosil® 300 from Degussa, a hydrophilic fumed silica, to hydrophobic modification with hexamethyldisilazane. The clearcoats produced from coating materials known from U.S. Pat. No. 5,384,367 A1 can be overcoated again with the same coating materials. The resultant clearcoats are said to adhere particularly firmly to the original clearcoats. The coating materials known from WO 96/34905 A produce coatings which are scratch-resistant and etch-resistant and have a good overall appearance.

International patent application WO 01/09231 A proposes using inorganic nanoparticles, based in particular on silica, aluminum or zirconium dioxide, which have been modified with special, hydroxyl-containing and/or carbamate-functional polysiloxanes. The effect of this modification is to accumulate the nanoparticles in the surface region of the coatings produced from the coating materials in question. This is said to improve the initial scratch-resistance and the post-weathering scratch-resistance of the coatings. Aside from the fact that the proposed modification of the nanoparticles is comparatively complex, there is a risk that the modified nanoparticles will separate during the storage of the coating materials and not only when the coatings are being formed.

The HALS light stabilizers used in the known coating materials apparently have no effect on the stability of the coating materials, since HALS of all kinds (HALS ether-substituted, alkyl-substituted and unsubstituted on the cyclic amino groups) are used without distinction.

### PROBLEM OF THE INVENTION

It is an object of the present invention to provide novel curable compositions which no longer have the disadvantages of the prior art but which are stable on storage even when economically preparable, unmodified or substantially unmodified, hydrophilic nanoparticles are used and which do not exhibit any turbidities or any increase in viscosity going as far as complete gelling or coagulation. The novel curable compositions ought to be suitable for the economic production of scratch-resistant self-supporting films and scratch-resistant moldings and also as coating materials, adhesives, and sealants for producing scratch-resistant coatings, adhesive films, and seals, particularly as coating materials for producing clear, transparent, scratch-resistant coatings.

The novel scratch-resistant self-supporting films and also the scratch-resistant moldings, coatings, adhesive films, and seals, especially the novel clear, transparent scratch-resistant coatings, ought to remain scratch-resistant and of outstanding overall appearance even in the case of outdoor use over many years.

It is a further object of the invention to provide a novel process for preparing curable compositions which allows' suitable starting products to be selected and curable compositions to be prepared therefrom in a simple manner, the resultant curable compositions being suitable for the economic production of scratch-resistant self-supporting films and scratch-resistant moldings and also as coating materials, adhesives, and sealants for producing scratch-resistant coatings, adhesive films, and seals, particularly as coating materials for producing clear, transparent, scratch-resistant coatings.

### THE SOLUTION PROVIDED BY THE INVENTION

The invention accordingly provides the novel curable compositions comprising:
(A) at least one constituent curable physically or thermally and/or with actinic radiation,
(B) at least one kind of inorganic nanoparticles having an electrophoretic mobility μe≦−0.5 (μm/s)/(V/cm) at a pH of 3 to 7, and
(C) at least one light stabilizer based on sterically hindered amines (HALS) having a pK_{b} of at least 9.0.

The novel curable compositions are referred to below as “compositions of the invention”.

The invention further provides the novel process for preparing curable compositions, which involves
(1) determining the electrophoretic mobility μe of inorganic nanoparticles and selecting therefrom at least one kind of inorganic nanoparticles (B) having an electrophoretic mobility μe≦−0.5 (μm/s)/(V/cm) at a pH of 3 to 7, and
(2) mixing the selected nanoparticles (B) with at least one light stabilizer (C) based on sterically hindered amines (HALS) having a pK_{b} of at least 9.0 and at least one constituent (A) curable thermally and/or with actinic radiation.

The novel process for preparing curable compositions is referred to below as “process of the invention”.

Further subject matter of the invention will emerge from the description.

### ADVANTAGES OF THE INVENTION

In the light of the prior art it was surprising and unforeseeable for the skilled worker that the object on which the present invention was based could be achieved by means of the compositions of the invention and by means of the process of the invention.

In particular it was surprising that the compositions of the invention no longer had the disadvantages of the prior art but instead were stable on storage, even when economically preparable, unmodified or substantially unmodified, hydrophiliic nanoparticles were used, and no longer exhibited gelling or coagulation. Indeed, no turbidity and no increase in viscosity were observed any longer; The compositions of the invention were outstandingly suitable for the economic production of scratch-resistant self-supporting films and scratch-resistant moldings and also as coating materials, adhesives, and sealants for the economic production of scratch-resistant coatings, adhesive films, and seals, especially as coating materials for producing clear, transparent, scratch-resistant coatings.

The scratch-resistant self-supporting films of the invention and also the scratch-resistant moldings, coatings, adhesive films, and seals of the invention, especially the novel clear, transparent, scratch-resistant coatings of the invention, remained scratch-resistant and of outstanding overall appearance even when used outdoors for many years.

Moreover, the process of the invention made it simple to select suitable key starting products and to produce compositions of the invention from them, the resultant compositions of the invention being outstandingly suitable for the economic production of scratch-resistant self-supporting films and scratch-resistant moldings and also as coating materials, adhesives, and sealants for the production of scratch-resistant coatings, adhesive films, and seals, especially as coating materials for producing clear, transparent, scratch-resistant coatings.

### DETAILED DESCRIPTION OF THE INVENTION

The compositions of the invention comprise at least one, in particular at least two, constituent(s) (A) selected from the group consisting of materials curable physically, thermally, with actinic radiation, and both thermally and with actinic radiation.

In the context of the present invention the term “physical curing” denotes the curing of a layer of a curable composition by filming through loss of solvent from the curable composition, with the linking within the layer taking place via looping of the polymer molecules of the binders (regarding the term cf. Römpp Lexikon Lacke and Druckfarben, Georg Thieme Verlag, Stuttgart, N.Y., 1998, “Binders”, pages 73 and 74). Or else filming takes place by way of the coalescence of binder particles (cf. Römpp Lexikon Lacke and Druckfarben, Georg Thieme Verlag, Stuttgart, N.Y., 1998, “Curing”, pages 274 and 275). Normally no crosslinking agents are required for this purpose. Where appropriate, physical curing may be assisted by atmospheric oxygen, by heat or by exposure to actinic radiation.

The thermally curable constituents (A) may in turn be self-crosslinking or externally crosslinking.

In the context of the present invention the term “self-crosslinking” refers to the capacity of a constituent (A), in particular of a binder (A), to enter into crosslinking reactions with itself. A prerequisite for this is that the constituent (A) already includes at least two kinds of complementary reactive functional groups which are necessary for crosslinking. Externally crosslinking curable compositions, on the other hand, are those in which at least one kind of the complementary reactive functional groups is present in a first constituent (A), especially a binder (A), and at least one other kind is present in a second constituent (A), especially a curing or crosslinking agent (A). For further details refer to Römpp Lexikon Lacke and Druckfarben, Georg Thieme Verlag, Stuttgart, N.Y., 1998, “Curing”, pages 274 to 276, especially page 275, bottom.

In the context of the present invention, actinic radiation means electromagnetic radiation, such as near infrared (NIR), visible light, UV radiation, X-rays and gamma radiation, especially UV radiation, and corpuscular radiation such as electron beams, beta radiation, alpha radiation, and neutron beams, especially electron beams.

Where thermal curing and actinic radiation curing are employed together for one composition of the invention, the terms “dual cure” and “dual-cure composition” are also used.

The compositions of the invention preferably comprise at least one binder (A).

The binders (A) are oligomeric and polymeric resins.

The binders (A) are preferably selected from the group consisting of random, alternating and/or block, linear and/or branched and/or comb polyaddition resins, polycondensation resins, and addition (co)polymers of ethylenically unsaturated monomers. For further details of these terms refer to Römpp Lexikon Lacke and Druckfarben, Georg Thieme Verlag, Stuttgart, N.Y., 1998, page 457, “Polyaddition” and “Polyaddition Resins (polyadducts)” and also pages 463 and 464, “Polycondensates”, “Polycondensation” and “Polycondensation Resins” and also pages 73 and 74, “Binders”.

Examples of suitable addition (co)polymers (A) are (meth)acrylate (co)polymers or partially hydrolyzed polyvinyl esters, especially (meth)acrylate copolymers.

Examples of suitable polyaddition resins and polycondensation resins (A) are polyesters, alkyds, polyurethanes, polylactones, polycarbonates, polyethers, epoxy resin-amine-adducts, polyureas, polyamides, polyimides, polyester-polyurethanes, polyether-polyurethanes or polyester-polyether-polyurethanes, especially polyester-polyurethanes.

Of these binders, the (meth)acrylate (co)polymers (A) have advantages and are therefore used with preference.

The self-crosslinking binders (A) of the thermally curable compositions and dual-cured compositions of the invention contain reactive functional groups which are able to enter into crosslinking reactions with groups of their own kind or with complementary reactive functional groups. The externally crosslinking binders (A) contain reactive functional groups which are able to enter into crosslinking reactions with complementary reactive functional groups present in crosslinking agents (A). Examples of suitable complementary reactive functional groups for use in accordance with the invention are compiled in the overview below. In the overview the variable R stands for an acyclic or cyclic aliphatic radical, an aromatic radical and/or an aromatic-aliphatic (araliphatic) radical; the variables R′ and R″ stand for identical or different aliphatic radicals or are linked to one another to form an aliphatic or heteroaliphatic ring.

OVERVIEW: Examples of complementary functional groups
Binder (A) and crosslinking agent (A)
or
Crosslinking agent (A) and binder (A)

| | |
|---|---|
| —SH | —C(O)—OH |
| —NN₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—O—R |
| | —NH—CH₂—O—R |
| | —NH—CH₂—OH |
| | —N(—CH₂—O—R)₂ |
| | —NH—C(O)—CH(—C(O)OR)₂ |
| | —NH—C(O)—CH(—C(O)OR)—(—C(O)—R) |
| | —NH—C(O)—NR′R″ |
| | >Si(OR)₂ |
| | 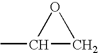 |
| | 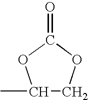 |
| —C(O)—OH | 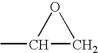 |
| | —N═C═N |
| | —C(O)—N(CH₂—CH₂—OH)₂ |

The selection of the respective complementary groups is guided on the one hand by the fact that during the preparation, storage and application, and also, where appropriate, during the melting, of the compositions of the invention they must not enter into any unwanted reactions, in particular any premature crosslinking, and/or must not inhibit or disrupt, where appropriate, the curing with actinic radiation, and on the other hand by the temperature range within which crosslinking is to take place.

In the case of the thermally curable or dual-cure compositions of the invention it is preferred to employ crosslinking temperatures of from room temperature to 180° C. Use is therefore made preferably of thio, hydroxyl, N-methylolamino, N-alkoxymethylamino, imino, carbamate, allophanate and/or carboxyl groups, preferably hydroxyl, carboxyl and/or carbamate groups, especially hydroxyl groups and/or carbamate groups, on the one hand and preferably of anhydride, carboxyl, epoxy, free and blocked isocyanate, urethane, methylol, methylol ether, N-methylolamino, N-alkoxymethylamino, siloxane, carbonate, amino, hydroxyl and/or beta-hydroxylalkylamide groups, preferably epoxy, free and blocked isocyanate, urethane and/or alkoxymethylamino groups, especially free and blocked isocyanate, urethane and/or alkoxymethylamino groups, on the other.

In the case of self-crosslinking thermosetting compositions of the invention the binders (A) contain in particular methylol, methylol ether and/or N-alkoxymethylamino groups.

Complementary reactive functional groups particularly suitable for use in the thermally curable or dual-cure compositions are
carbamate groups on the one hand and N-alkoxymethylamino groups on the other, and also
hydroxyl groups on the one hand and free and blocked isocyanate, urethane or N-alkoxymethylamino groups on the other.

The functionality of the binders (A) in respect of the above-described reactive functional groups may vary very widely and is guided in particular by the target crosslinking density and/or by the functionality of the crosslinking agents (A) employed in each case. For example, in the case of carboxyl-containing binders (A) the acid number is preferably from 10 to 100, more preferably from 15 to 80, with particular preference from 20 to 75, with very particular preference from 25 to 70, and in particular from 30 to 65 mg KOH/g. Or in the case of hydroxyl-containing binders (A) the OH number is preferably from 15 to 300, more preferably from 20 to 250, with particular preference from 25 to 200, with very particular preference from 30 to 150, and in particular from 35 to 120 mg KOH/g. Or in the case of epoxy-containing binders (A) the epoxy equivalent weight is preferably from 400 to 2,500, more preferably from 420 to 2,200, with particular preference from 430 to 2,100, with very particular preference from 440 to 2,000 and in particular from 440 to 1,900 equivalents/g.

The hydroxyl-containing binders (A) preferably include a minor amount of carboxyl groups, preferably corresponding to an acid number<30, more preferably <25 and in particular <20 mg KOH/g.

The above-described complementary reactive functional groups can be incorporated into the binders (A) in accordance with the conventional methods of polymer chemistry. This may take place, for example, by the incorporation of monomers which carry the corresponding reactive functional groups and/or with the aid of polymer-analogous reactions.

Examples of suitable olefinically unsaturated monomers containing reactive functional groups are
(a1) monomers which carry at least one hydroxyl, amino, N-alkoxymethylamino, carbamate, allophanate or imino group in the molecule, such as
   hydroxylalkyl esters of acrylic acid, methacrylic acid or another alpha,beta-olefinically unsaturated carboxylic acid which derive from an alkylene glycol which has been esterified with the acid or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleinate, fumarate, or itaconate; or hydroxycycloalkyl esters such as 1,4-bis(hydroxymethyl)cyclohexane, octahydro-4,7-methano-1H-indenedimethanol or methylpropanediol monoacrylate, monomethacrylate, monethacrylate, monocrotonate, monomaleate, monofumarate or monitaconate; reaction products of cyclic esters, such as epsilon-caprolactone, for example, and these hydroxyalkyl or cycloalkyl esters;
   olefinically unsaturated alcohols such as allyl alcohol;
   polyols such as trimethylolpropane mono- or diallyl ether or pentaerythritol mono-, di- or triallyl ether;
   reaction products of acrylic acid and/or methacrylic acid with the glycidyl ester of an alpha-branched monocarboxylic acid having 5 to 18 carbon atoms per molecule, in particular of a Versatic® acid, or, instead of the reaction product, an equivalent amount of acrylic and/or methacrylic acid which is then reacted, during or after the polymerization reaction, with the glycidyl ester of an alpha-branched monocarboxylic acid having 5 to 18 carbon atoms per molecule, in particular of a Versatic® acid;
   aminoethyl acrylate, aminoethyl methacrylate, allylamine or N-methyliminoethyl acrylate;
   N,N-di(methoxymethyl)aminoethyl acrylate or methacrylate or N,N-di(butoxymethyl)aminopropyl acrylate or methacrylate;
   (meth)acrylamides such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)-(meth)acrylamide;
   acryloyloxy or methacryloyloxyethyl, -propyl or -butyl carbamate or allophanate; further examples of suitable monomers containing carbamate groups are described in patents U.S. Pat. No. 3,479,328 A1, U.S. Pat. No. 3,674,838 A1, U.S. Pat. No. 4,126,747 A1, U.S. Pat. No. 4,279,833 A1, and U.S. Pat. No. 4,340,497 A1;
(a2) monomers which carry at least one acid group per molecule, such as
   acrylic acid, methacrylic acid, ethacrylic acid, crotonic acid, maleic acid, fumaric acid or itaconic acid;
   olefinically unsaturated sulfonic or phosphonic acids or their partial esters;
   mono(meth)acryloyloxyethyl maleates, succinates or phthalates; or
   vinylbenzoic acid (all isomers), alpha-methylvinybenzoic acid (all isomers) or vinybenzenesulfonic acid (all isomers);
(a3) monomers containing epoxide groups, such as the glycidyl ester of acrylic acid, methacrylic acid, ethacrylic acid, crotonic acid, maleic acid, fumaric acid or itaconic acid, or allyl glycidyl ether.

They are used preferably for preparing (meth)acrylate copolymers (A).

Higher polyfunctional monomers of the type described above are generally used in minor amounts. In the context of the present invention, minor amounts of higher polyfunctional monomers are amounts which do not lead to crosslinking or gelling of the copolymers (A), especially of the (meth)acrylate copolymers (A), unless the intention is to prepare crosslinked polymeric microparticles (A).

Examples of suitable monomer units for introducing reactive functional groups into polyesters or polyester-polyurethanes (A) are 2,2-dimethylolethylamine or -propylamine blocked with a ketone, the resultant ketoxime group being hydrolyzed again following its incorporation; or compounds which contain two hydroxyl groups or two primary and/or secondary amino groups and also at least one acid group, in particular at least one carboxyl group and/or at least one sulfonic acid group, such as dihydroxypropionic acid, dihydroxysuccinic acid, dihydroxybenzoic acid, 2,2,-dimethylolacetic acid, 2,2-dimethylolpropionic acid, 2,2-dimethylolbutyric acid, 2,2-dimethylolpentanoic acid, alpha,omega-diaminovaleric acid, 3,4-diaminobenzoic acid, 2,4-diaminotoluenesulfonic acid or 2,4-diaminodiphenyl ether sulfonic acid.

One example of introducing reactive functional groups by way of polymer-analogous reactions is the reaction of hydroxyl-containing resins with phosgene, producing resins containing chloroformate groups, and the polymer-analogous reaction of the chloroformate-functional resins with ammonia and/or primary and/or secondary amines to give resins containing carbamate groups. Further examples of suitable such methods are known from patents U.S. Pat. No. 4,758,632 A1, U.S. Pat. No. 4,301,257 A1 and U.S. Pat. No. 2,979,514 A1.

The binders (A) of the dual-cure compositions of the invention or of the compositions of the invention that are curable purely with actinic radiation further contain on average per molecule at least one, preferably at least two, group(s) having at least one bond which can be activated with actinic radiation.

In the context of the present invention a bond which can be activated with actinic radiation means a bond which when exposed to actinic radiation becomes reactive and, together with other activated bonds of its kind, enters into addition-polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds and also carbon-carbon triple bonds. Of these, the carbon-carbon double bonds are particularly advantageous and are therefore used with very particular preference in accordance with the invention. For the sake of brevity they are referred to below as “double bonds”.

Accordingly, the inventively preferred group which can be activated by actinic radiation contains one double bond or two, three or four double bonds. Where more than one double bond is used the double bonds may be conjugated. In accordance with the invention, however; it is of advantage if the double bonds are present in isolation, in particular each terminally, within the group in question. It is of particular advantage in accordance with the invention to use two double bonds, especially one double bond.

The dual-cure binder (A) or the binder (A) curable purely with actinic radiation contains on average at least one of the above-described groups which can be activated with actinic radiation. This means that the functionality of the binder in this respect is integral, i.e., for example, is two, three, four, five or more, or non-integral, i.e., for example, 2.1 to 10.5 or more. Which functionality is chosen depends on the requirements imposed on the respective dual-cure compositions of the invention or the compositions of the invention that are curable with actinic radiation.

Where on average more than one group which can be activated with actinic radiation is employed per molecule, the groups are structurally different from one another or of the same structure.

Where they are structurally different from one another, this means in the context of the present invention that two, three, four or more, but especially two, groups which can be activated with actinic radiation are used which derive from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, iosprenyl ether, isopropenyl ether, allyl ether or butenyl ether groups; or dicyclopentadienyl ester, norbornenyl ester, isoprenyl ester, isopropenyl ester, allyl ester or butenyl ester groups, but especially acrylate groups.

The groups are preferably attached to the respective parent structures of the binders by way of urethane, urea, allophanate, ester, ether and/or amide groups, but especially by way of ester groups. This normally takes place as a result of conventional polymer-analogous reactions such as, for instance, the reaction of pendant glycidyl groups with the above-described olefinic saturated monomers containing an acid group, of pendant hydroxyl groups with the halides of these monomers, of hydroxyl groups with isocyanates containing double bonds, such as vinyl isocyanate, methacryloyl isocyanate and/or 1-(1-isocyanato-1-methylethyl-3-(1-methylethenyl)benzene(TMI® from Cytec), or of isocyanate groups with the above-described hydroxyl-containing monomers.

Alternatively, in the dual-cure compositions, use may be made of mixtures of binders (A) that are curable by means of heat alone and binders (A) that are curable with actinic radiation alone.

There are fundamentally no special features to the physical composition of the binders (A); instead they suitably include
all the binders intended for use in powder clearcoat slurries curable thermally or both thermally and with actinic radiation and described in U.S. Pat. No. 4,268,542 A1 or U.S. Pat. No. 5,379,947 A1 and in patent applications DE 27 10 421 A1, DE 195 40 977 A1, DE 195 18 392 A1, DE 196 17 086 A1, DE 196 13 547 A1, DE 196 18 657 A1, DE 196 52 813 A1, DE 196 17 086 A1, DE 198 14 471 A1, DE 198 41 842 A1 and DE 198 41 408 A1, in German patent applications DE 199 08 018.6 and DE 199 08 013.5, unpublished at the priority date of the present specification, or in European patent EP 0 652 264 A1;
all the binders intended for use in dual-cure clearcoat materials and described in patent applications DE 198 35 296 A1, DE 197 36 083 A1 and DE 198 41 842 A1, or
all the binders intended for use in thermally curable powder clearcoat materials and described in German patent application DE 42 22 194 A1, the BASF Lacke & Farben AG product information bulletin “Pulverlacke”, 1990, or the BASF Coatings AG brochure “Pulverlacke, Pulverlacke für industrielle Anwendungen”, January 2000.

In the case of the compositions curable thermally or both thermally and with actinic radiation use is made here predominantly of (meth)acrylate copolymers (A).

Suitable additional binders (A) for the dual-cure compositions of the invention or suitable sole binders (A) for the compositions of the invention that are curable purely with actinic radiation include the binders intended for use in UV-curable clearcoats, powder clearcoats, and powder clearcoats that are described in European patent applications EP 0 928 800 A1, EP 0 636 669 A1, EP 0 410 242 A1, EP 0 783 534 A1, EP 0 650 978 A1, EP 0 650 979 A1, EP 0 650 985 A1, EP 0 540 884 A1, EP 0 568 967 A1, EP 0 054 505 A1 and EP 0 002 866 A1, in German patent applications DE 198 35 206 A1, DE 197 09 467 A1, DE 42 03 278 A1, DE 33 16 593 A1, DE 38 36 370 A1, DE 24 36 186 A1 and DE 20 03 579 B1, in international patent applications WO 97/46549 and WO 99/14254, or in American patents U.S. Pat. No. 5,824,373 A1, U.S. Pat. No. 4,675,234 A1, U.S. Pat. No. 4,634,602 A1, 4,424,252 A1, U.S. Pat. No. 4,208,313 A1, U.S. Pat. No. 4,163,810 A1, U.S. Pat. No. 4,129,488 A1, U.S. Pat. No. 4,064,161 A1 and U.S. Pat. No. 3,974,303 A1.

The preparation of the binders (A) also has no special features in terms of method but instead takes place with the aid of the conventional methods of polymer chemistry, as described in detail for example in the patent applications and patents set out above.

Examples of suitable preparation processes for (meth)acrylate copolymers (A) are described, moreover, in European patent application EP 0 767 175 A1, in German patents DE 22 14 650 B1 and DE 27 49 576 B1, and in American patents U.S. Pat. No. 4,091,048 A1, U.S. Pat. No. 3,781,379 A1, U.S. Pat. No. 5,480,493 A1, U.S. Pat. No. 5,475,073 A1 and U.S. Pat. No. 5,534,598 A1, or in the standard work Houben-Weyl, Methoden der organischen Chemie, 4th Edition, Volume 14/1, pages 24 to 255, 1961. Suitable reactors for the copolymerization include the conventional stirred tanks, stirred tank cascades, tube reactors, loop reactors or Taylor reactors, as described, for example, in patents and patent applications DE 1 071 241 B1, EP 0 498 583 A1 and DE 198 28 742 A1 or in the article by K. Kataoka in Chemical Engineering Science, Volume 50, Number 9, 1995, pages 1409 to 1416.

The preparation of polyesters and alkyd resins is also described, for example, in the standard work Ullmanns Encyklopädie der technischen Chemie, 3rd Edition, Volume 14, Urban & Schwarzenberg, Munich, Berlin, 1963, pages 80 to 89 and 99 to 105, and also in the following books: “Résines Alkydes-Polyesters” by J. Bourry, Dunod, Paris, 1952, “Alkyd Resins” by C. R. Martens, Reinhold Publishing Corporation, New York, 1961, and “Alkyd Resin Technology” by T. C. Patton, Interscience Publishers, 1962.

The preparation of polyurethanes and/or acrylated polyurethanes (A) is also described, for example, in patent applications EP 0 708 788 A1, DE 44 01 544 A1 and DE 195 34 361 A1.

The amount of binders (A) in the compositions of the invention may vary very widely and is guided in particular by whether they are curable physically, thermally with self-crosslinking and/or with actinic radiation. In these cases the amount may be preferably from 20 to 99.9%, more preferably from 25 to 99.7%, with particular preference from 30 to 99.5%, with very particular preference from 35 to 99.3%, and in particular from 40 to 99.1% by weight, based in each case on the solids of the compositions of the invention. In the other cases (curable thermally or both thermally and with actinic radiation, with external crosslinking) the binder content is preferably from 10 to 80%, more preferably from 15 to 75%, with particular preference from 20 to 70%, with very particular preference from 25 to 65%, and in particular from 30 to 60% by weight, based in each case on the solids of the compositions of the invention.

The externally crosslinking compositions curable thermally or both thermally and with actinic radiation include at least one crosslinking agent (A) which contains reactive functional groups complementary to the reactive functional groups of the binders (A). The skilled worker is therefore able easily to select the crosslinking agents (A) suitable for a given powder slurry.

Examples of suitable crosslinking agents (A) are
amino resins, as described for example in Römpp Lexikon Lacke & Druckfarben, Georg Thieme Verlag, 1998, page 29, “amino resins”, in the textbook “Lackadditive” [Additives for coatings] by Johan Bieleman, Wiley-VCH, Weinheim, N.Y., 1998, page 242 ff., in the book “Paints, Coatings and Solvents”, second, completely revised edition, edited by D. Stoye and W. Freitag, Wiley-VCH, Weinheim, N.Y., 1998, page 80 ff., in patents U.S. Pat. No. 4,710,542 A1 and EP 0 245 700 A1, and also in the article by B. Singh and coworkers, “Carbamylmethylated Melamines, Novel Crosslinkers for the Coatings Industry”, in Advanced Organic Coatings Science and Technology Series, 1991, volume 13, pages 193 to 207;
Carboxyl-containing compounds or resins, as described for example in patent DE 196 52 813 A1 or 198 41 408 A1, especially 1,12-dodecane-dicarboxylic acid;
Epoxy-functional compounds or resins, as described for example in patents EP 0 299 420 A1, DE 22 14 650 B1, DE 27 49 576 B1, U.S. Pat. No. 4,091,048 A1 and U.S. Pat. No. 3,781,379 A1;
free and blocked polyisocyanates, as described for example in patents U.S. Pat. No. 4,444,954 A1, DE 196 17 086 A1, DE 196 31 269 A1, EP 0 004 571 A1 and EP 0 582 051 A1;
beta-hydroxyalkylamides such as N,N,N′,N′-tetrakis(2-hydroxyethyl)adipamide or N,N,N′,N′-tetrakis(2-hydroxypropyl)adipamide; and/or
tris(alkoxycarbonylamino)triazines, as described in patents U.S. Pat. No. 4,939,213 A1, U.S. Pat. No. 5,084,541 A1, U.S. Pat. No. 5,288,865 A1 and EP 0 604 922 A1.

Preference is given to using tris(alkoxycarbonylamino)triazines.

The amount of the crosslinking agents (A) in the compositions of the invention may likewise vary very widely and is guided by the requirements of the case in hand, in particular by the number of reactive functional groups present. The amount is preferably from 1.0 to 50%, more preferably from 2.0 to 45%, with particular preference from 3.0 to 40%, with very particular preference from 4.0 to 35% and in particular from 5.0 to 30% by weight, based in each case on the solids of the compositions of the invention.

The compositions of the invention comprise at least one, especially one, kind of inorganic nanoparticles (B) having an electrophoretic mobility μe≦−0.5, preferably ≦−1, and in particular ≦−1.5 (μm/s)/(V/cm) at a pH of 3 to 7. The electrophoretic mobility can be determined with the aid of laser Doppler electrophoresis, employing the Zetasizer® 3000 from Malvern as measuring instrument. Alternatively, microelectrophoretic (microscopic) measurement methods are suitable.

The nanoparticles (B) are preferably selected from the group consisting of main group metals, transition group metals, and the compounds thereof. The main group and transition group metals are preferably selected from metals from main groups three to five, transition groups three to six and one and two of the periodic table of the elements and also the lanthanides. Particular preference is given to using boron, aluminum, gallium, silicon, germanium, tin, arsenic, antimony, silver, zinc, titanium, zirconium, hafnium, vanadium, niobium, tantalum, molybdenum, tungsten and cerium, especially aluminum, silicon, silver, cerium, titanium and zirconium.

The compounds of the metals are preferably oxides, oxide hydrates, sulfates or phosphates, especially oxides.

Preference is given to using silver, silica, alumina, hydrated alumina, titanium dioxide, zirconium oxide, cerium oxide and mixtures thereof, particular preference to silver, cerium oxide, silica, hydrated alumina, and mixtures thereof, and very particular preference to silica.

In particular, the compound in question is fumed silica. The agglomerates and aggregates of its primary particles have a catenated structure and are prepared by the flame hydrolysis of silicon tetrachloride in an oxyhydrogen flame. The fumed silica is hydrophilic per se and can be used without further modification or following a slight modification to its surface as nanoparticles (B). “Slight” means that when modifying the surface only a small part, in particular <5 equivalent %, of the silanol groups present on the surface of the nanoparticles are reacted with conventional modifiers.

The nanoparticles (B) for modification preferably have a primary particle size<50 nm, more preferably from 5 to 50 nm, in particular from 10 to 30 nm.

The amount of the above-described nanoparticles (B) for use in accordance with the invention in the compositions of the invention may vary very widely and is guided by the requirements of the case in hand. The amount is preferably from 0.1 to 40%, more preferably from 0.5 to 35%, with particular preference from 0.1 to 40%, with very particular preference from 1.5 to 35%, and in particular from 2.0 to 30% by weight, based in each case on the solids of the compositions of the invention.

The compositions of the invention further comprise at least one, especially one, light stabilizer (C) based on sterically hindered amines (HALS) having a pK_{b} of at least 9.0, in particular at least 9.5. The light stablizers (C) are preferably selected from the group of the aminoether-functionalized HALS. Use is made in particular of the aminoether-functionalized 2,2,6,6-tetramethylpiperidine derivatives, such as bis(1-octyloxy-2,2,6,6-tetramethyl-4-piperidyl) sebacate, which is sold by Ciba Specialty Chemicals under the brand name Tinuvin® 123. It is also possible to use aminoether-functionalized HALS which contain per molecule at least one reactive functional group complementary to the reactive functional groups of the crosslinking agents and/or binders (A), so that they are immobilized during the thermal crosslinking of the compositions of the invention.

The compositions of the invention preferably contain the light stabilizers (C) in an amount of from 0.1 to 5%, more preferably from 0.2 to 4% and in particular from 0.3 to 3%, by weight, based in each case on the solids of the compositions of the invention.

The compositions of the invention may further comprise at least one additive (D). They are preferably selected from the group consisting of photoinitiators; molecularly dispersely soluble dyes; low-boiling and high-boiling (“long”) organic solvents; devolatilizers; wetting agents; emulsifiers; slip additives; polymerization inhibitors; thermal crosslinking catalysts; thermolabile free-radical initiators; adhesive promoters; leveling agents; film-forming auxiliaries; rheology aids, such as thickeners and pseudoplastic sag control agents, SCAs; triazine-based and benzo-triazole-based light stabilizers; flame retardants; corrosion inhibitors; free-flow aids; waxes; siccatives; biocides; and flatting agents.

Examples of suitable additives (D) are described in detail in the textbook “Lackadditive” by Johan Bieleman, Wiley-VCH, Weinheim, N.Y., 1998, in D. Stoye and W. Freitag (editors), “Paints, Coatings and Solvents”, second, completely revised edition, Wiley-VHC, Weinheim, N.Y., 1998, “14.9. Solvent Groups”, pages 327 to 373, in German patent application DE 199 14 896 A1, column 14 line 26 to column 15 line 46, or in German patent application DE 199 08 018 A1, page 9 line 31 to page 8 line 30. For further details refer to German patent applications DE 199 04 317 A1, DE 198 18 735 A1 and DE 198 55 125 A1, or to German patent DE 197 09 467 C1.

The compositions of the invention comprising the above-described additives (D) are used for producing clear, transparent, cured compositions, in particular for producing clear, transparent coatings, adhesive films, seals, self-supporting films and moldings.

However, the compositions of the invention may also be pigmented. In that case they preferably comprise as additive or as one of the additives (D) at least one conventional pigment selected from the group consisting of organic and inorganic, transparent and opaque, color and/or effect, electrically conductive, magnetically shielding, and fluorescent pigments and fillers.

The pigmented compositions of the invention are used in particular as coating materials, such as electrocoat materials, surfacers, basecoat materials, and solid-color topcoat materials, for producing pigmented coatings, such as electrocoats, surfacer coats or antistonechip primer coats, basecoats and solid-color topcoats, or for producing pigmented adhesive films, seals, self-supporting films, and moldings.

Where exclusively non-opaque transparent pigments (D) are used the pigmented compositions of the invention may also be used for producing pigmented, transparent cured compositions, especially transparent coatings, adhesive films, seals, self-supporting films, and moldings.

The compositions of the invention are prepared preferably by mixing the above-described constituents in suitable mixing equipment such as stirred tanks, stirrer mills, extruders, compounders, Ultraturrax, inline dissolvers, static mixers, micromixers, toothed-wheel dispersers, pressure relief nozzles and/or microfluidizers. In these cases it is preferred to operate in the absence of light with a wavelength λ<550 nm or in complete absence of light, in order to prevent premature crosslinking of the compositions of the invention, when the compositions of the invention are curable with actinic radiation or by a dual-cure mechanism.

To produce the moldings and self-supporting films of the invention the compositions of the invention are applied to conventional, temporary or permanent, substrates. To produce the self-supporting films and moldings of the invention it is preferred to use conventional temporary substrates, such as belts made of metal or plastic or hollow bodies made of metal, glass, plastic, wood or ceramic, which can easily be removed without damaging the self-supporting films and moldings of the invention.

Where the compositions of the invention are used for producing coatings, adhesive films, primers, and seals, permanent substrates are employed, such as means of transport, including aircraft, water vehicles, rail vehicles, muscle-powered vehicles, and motor vehicles, and parts thereof, the interior and exterior of buildings and parts thereof, doors, windows, furniture, hollow glassware, coils, freight containers, packaging, small industrial parts, optical components, electrical components, mechanical components and components for white goods. The self-supporting films and moldings of the invention may likewise serve as substrates.

In terms of method the application of the liquid compositions of the invention has no special features but instead can take place by any conventional application method, such as spraying, squirting, knife coating, brushing, pouring, dipping, trickling or rolling, for example.

The application of the compositions of the invention in powder form also has no special features as far as its method is concerned but instead takes place, for example, by the conventional fluidized-bed methods, such as are known, for example, from the BASF Coatings AG brochures “Pulverlacke fur industrielle Anwendungen”, January 2000 or “Coatings Partner, Pulverlack Spezial” 1/2000, or Römpp Lexikon Lacke & Druckfarben, George Thieme Verlag, Stuttgart, N.Y., 1998, pages 187 and 188, “Electrostatic powder spraying”, “Electrostatic spraying” and “Electrostatic fluidized-bath process”.

During application it is advisable to work in the absence of actinic radiation in order to prevent premature crosslinking of the compositions of the invention, when the compositions of the invention are curable with actinic radiation or a dual-cure mechanism.

The applied compositions of the invention which can be cured with actinic radiation or by a dual-cure mechanism are preferably cured using UV radiation. For irradiation it is preferred to use a radiation dose of from 100 to 6,000, more preferably from 200 to 3,000, more preferably still from 300 to 2,000, and with particular preference from 500 to 1,800 mJ cm⁻², the region<1,700 mJ cm⁻² being especially preferred.

The radiation intensity may vary widely. It is guided in particular by the radiation dose on the one hand and by the irradiation time on the other. For a given radiation dose, the irradiation time is guided by the belt speed or rate of advance of the substrates in the irradiating unit, and vice versa.

Sources which can be used for the UV radiation include all conventional UV lamps. Flash lights as well are appropriate. As UV lamps it is preferred to use mercury vapor lamps, preferably low, medium and high pressure mercury vapor lamps, especially medium pressure mercury vapor lamps. Particular preference is given to using unmodified mercury vapor lamps plus appropriate filters or modified, especially doped, mercury vapor lamps.

It is preferred to use gallium-doped and/or iron-doped, especially iron-doped, mercury vapor lamps, as described, for example, in R. Stephen Davidson, “Exploring the Science, Technology and Applications of U.V. and E.B. Curing”, Sita Technology Ltd., London, 1999, Chapter I, “An Overview”, page 16, figure 10, or Dipl.-Ing. Peter Klamann, “eltosch System-Kompetenz, UV-Technik; Leitfaden für Anwender”, page 2, October 1998.

Examples of suitable flash lights are flash lights from the company VISIT.

The distance of the UV lamps from the applied compositions of the invention may vary surprisingly widely and can therefore be adapted very effectively to the requirements of the case in hand. The distance is preferably from 2 to 200 cm, more preferably from 5 to 100 cm, with particular preference from 10 to 50 cm and in particular from 15 to 30 cm. The lamp arrangement can also be adapted to the circumstances of the substrate and the process parameters. In the case of substrates of complex shape, such as are envisaged for automobile bodies, the regions not accessible to direct radiation (shadow regions), such as cavities, folds, and other structural undercuts, may be cured using pointwise, small-area or all-round emitters, in conjunction with an automatic movement means for the irradiation of cavities or edges.

Irradiation may be carried out under an oxygen-depleted atmosphere. “Oxygen-depleted” means that the oxygen content of the atmosphere is less than that of air (20.95% by volume). In principle the atmosphere may also be oxygen-free, i.e., may comprise an inert gas. Owing to the lack of the inhibitory effect of oxygen, however, this may result in a sharp acceleration to the radiation cure, possibly leading to inhomogeneities and stresses in the cured compositions of the invention. It is therefore of advantage not to lower the oxygen content of the atmosphere to 0% by volume.

In the case of the applied compositions of the invention curable physically, thermally and by dual cure, the thermal cure may take place, for example, with the aid of a gaseous, liquid and/or solid hot medium, such as hot air, heated oil or heated rollers, or by means of microwave radiation, infrared light and/or near infrared (NIR) light. Heating takes place preferably in a forced-air oven or by irradiation with IR and/or NIR lamps. As in the case of the actinic radiation cure, the thermal cure may also take place in stages. Thermal curing takes place advantageously at temperatures from room temperature to 200° C.

Both the thermal cure and the actinic radiation cure may be carried out in stages. In that case they may take place one after the other (sequentially) or simultaneously. In accordance with the invention, sequential curing is of advantage and is therefore used with preference. It is particularly advantageous to carry out the thermal cure after the actinic radiation cure.

The resultant self-supporting films, moldings, coatings, adhesive films and seals of the invention are outstandingly suitable for the coating, adhesive bonding, sealing, wrapping and packaging of means of transport, including aircraft, water vehicles, rail vehicles, muscle-powered vehicles, and motor vehicles, and parts thereof, the interior and exterior of buildings and parts thereof, doors, windows, furniture, and in the context of the industrial coating of hollow glassware, coils, freight containers, packaging, small industrial parts, such as nuts, bolts or hubcaps, optical components, electrical components, such as windings, including coils and stators and rotors for electrical motors, mechanical components and components for white goods, including household appliances, boilers, and radiators.

In particular, however, the compositions of the invention are used as coatings materials for producing clear, transparent coatings, preferably clearcoats, more preferably clearcoats of multicoat color and/or effect, electrically conductive, magnetically shielding or fluorescent paint systems, with particular preference clearcoats of multicoat color and/or effect paint systems, and especially clearcoats of multicoat color and/or effect paint systems which possess what is referred to as automobile quality (cf. also European patent EP 0 352 298 B1, page 15 line 42 to page 17 line 40). The multicoat paint systems of the invention are preferably produced by the conventional wet-on-wet techniques (cf., for example, German patent applications DE 199 14 896 A1, column 16 line 54 to column 18 line 57, and DE 199 30 067 A1, page 15 line 25 to page 16 line 36).

The resultant coatings, moldings and self-supporting films of the invention, especially the multicoat color and/or effect paint systems of the invention, are simple to produce and have outstanding appearance properties and very high light stability, chemical resistance, water resistance, condensation resistance, weathering stability, and etch resistance. In particular they are free from turbidities and inhomogeneities. They combine outstanding scratch resistance and abrasion resistance with outstanding surface hardness and acid resistance. Surprisingly, in the realistic AMTEC test, the coatings, especially the clearcoats, suffer a difference in gloss before and after exposure of less than 30, preferably less than 27, and in particular less than 25 units, which underlines their particularly high scratch resistance.

The adhesive films of the invention join a very wide variety of substrates to one another, firmly and durably, and have a high chemical and mechanical stability even in the case of extreme temperatures and/or temperature fluctuations.

Similarly, the seals of the invention seal the substrates durably and possess high chemical and mechanical stability even in the case of extreme temperatures and/or temperature fluctuations and even in conjunction with exposure to aggressive chemicals.

Accordingly, the primed or unprimed substrates which are commonly employed in the technology fields set out above and which are coated with at least one coating of the invention, adhesively bonded with at least one adhesive film of the invention, sealed with at least one seal of the invention and/or wrapped or packaged with at least one self-supporting film of the invention or at least one molding of the invention combine a particularly advantageous profile of performance properties with a particularly long service life, so making them particularly attractive both economically and environmentally.

### EXAMPLES

### Preparation Example 1

The Preparation of a Binder (A1)

A laboratory reactor with a useful capacity of 4 l, equipped with a stirrer, two dropping funnels for the monomer mixture and initiator solution, respectively, a nitrogen inlet tube, thermometer, and reflux condenser, was charged with 897 g of an aromatic hydrocarbons fraction having a boiling range of 158-172° C. The solvent was heated to 140° C. After 140° C. had been reached, a monomer mixture of 487 g of t-butyl acrylate, 215 g of n-butyl methacrylate, 143 g of styrene, 572 g of hydroxypropyl methacrylate and 14 g of acrylic acid was metered into the reactor at a uniform rate over the course of 4 hours and an initiator solution of 86 g of t-butyl perethylhexanoate in 86 g of the aromatic solvent described was metered into the reactor at a uniform rate over the course of 4.5 hours. The metering of the monomer mixture and of the initiator solution was commenced simultaneously. After the end of the initiator feed the reaction mixture was held at 140° C. for two hours more and then cooled. The resultant polymer solution, diluted with a mixture of 1-methoxy-2-propyl acetate, butylglycol acetate and butyl acetate, had a solids content of 53%, determined in a forced-air oven at 130° C. for 1 h, an acid number of 10 mg KOH/g, and a viscosity of 23 dPas (measured on a 60% dilution of the polymer solution in the aromatic solvent described, using an ICI cone and plate viscometer at 23° C.).

### Preparation Example 2

The Preparation of a Binder (a2)

A laboratory reactor with a useful capacity of 4 l, equipped with a stirrer, two dropping funnels for the monomer mixture and initiator solution, respectively, a nitrogen inlet tube, thermometer, and reflux condenser, was charged with 720 g of an aromatic hydrocarbons fraction having a boiling range of 158-172° C. The solvent was heated to 140° C. After 140° C. had been reached, a monomer mixture of 537 g of 2-ethylhexyl methacrylate, 180 g of n-butyl methacrylate, 210 g of styrene, 543 g of hydroxyethyl acrylate and 30 g of acrylic acid was metered into the reactor at a uniform rate over the course of 4 hours and an initiator solution of 150 g of t-butyl perethylhexanoate in 90 g of the aromatic solvent described was metered into the reactor at a uniform rate over the course of 4.5 hours. The metering of the monomer mixture and of the initiator solution was commenced simultaneously. After the end of the initiator feed the reaction mixture was held at 140° C. for two hours more and then cooled. The resultant polymer solution had a solids content of 65%, determined in a forced-air oven at 130° C. for 1 h, an acid number of 17 mg KOH/g, and a viscosity of 16 dPas (measured on a 60% dilution of the polymer solution in the aromatic solvent described, using an ICI cone and plate viscometer at 23° C.).

### Preparation Example 3

The Preparation of a Grinding Resin

A laboratory reactor with a useful capacity of 4 l, equipped with a stirrer, two dropping funnels for the monomer mixture and initiator solution, respectively, a nitrogen inlet tube, thermometer, and reflux condenser, was charged with 720 g of an aromatic hydrocarbons fraction having a boiling range of 158-172° C. The solvent was heated to 140° C. After 140° C. had been reached, a monomer mixture of 450 g of 2-ethylhexyl methacrylate, 180 g of n-butyl methacrylate, 210 g of styrene, 180 g of hydroxyethyl acrylate, 450 g of 4-hydroxybutyl acrylate and 30 g of acrylic acid was metered into the reactor at a uniform rate over the course of 4 hours and an initiator solution of 150 g of t-butyl perethylhexanoate in 90 g of the aromatic solvent described was metered into the reactor at a uniform rate over the course of 4.5 hours. The metering of the monomer mixture and of the initiator solution was commenced simultaneously. After the end of the initiator feed the reaction mixture was held at 140° C. for two hours more and then cooled. The resultant polymer solution had a solids content of 65%, determined in a forced-air oven at 130° C. for 1 h, an acid number of 15, and a viscosity of 3 dPas (measured on a 60% dilution of the polymer solution in the aromatic solvent described, using an ICI cone and plate viscometer at 23° C.).

### Preparation Example 4

The Preparation of a Rheology Aid (D)

A laboratory stirrer mill from Vollrath was charged with 800 g of millbase consisting of 323.2 g of the grinding resin from preparation example 3, 187.2 g of butanol, 200.8 g of xylene and 88.8 g of Aerosil® 812 (Degussa AG, Hanau), together with 100 g of quartz sand (grain size 0.7-1 mm), and the contents of the mill were ground for 30 minutes with water cooling.

### Inventive Example 1 and Comparative Example C1

The Preparation of the Clearcoat Materials 1 and C1

The clearcoat materials 1 (Inventive Example 1) and C1 (Comparative Example C1) were prepared by mixing the constituents indicated in Table 1 and homogenizing the respective mixtures.

TABLE 1
The physical composition of the clearcoat materials 1 and C1

| | Parts by weight: | |
|---|---|---|
| | Example 1 | Example C1 |
| Constituent | (inventive) | (comparative) |
| Binder solution (A1) from preparation | 31.32 | 31.32 |
| Example 1 | | |
| Binder solution (A2) from preparation | 8.0 | 8.0 |
| Example 2 | | |
| Rheological aid (D) from preparation | 2.45 | 2.45 |
| Example 3 | | |
| TACT ® (commercial | 21.0 | 21.0 |
| tris(alkoxycarbonylamino)triazine from | | |
| Cytec) | | |
| Butylglycol acetate | 2.35 | 2.35 |
| Baysilon ® OL 44 (commercial leveling | 0.03 | 0.03 |
| agent based on a modified polysiloxane, | | |
| from Bayer AG) | | |
| Highlink ® OG 502-31 (dispersion of | 30.5 | 30.5 |
| unmodified silica nanoparticles^{a)}, 30 percent | | |
| in isopropanol from Clariant) | | |
| Bis(1-octyloxy-2,2,6,6-tetramethyl-4- | 2.0 | — |
| piperidyl) sebacate (pK_{b} >9.0, | | |
| Tinuvin ® 123 from Ciba Specialty | | |
| Chemicals) | | |
| Bis(1,2,2,6,6-pentamethyl-4-piperidyl) | — | 2.0 |
| sebacate (pK_{b} <9.0, Tinuvin ® 292 | | |
| from Ciba Specialty Chemicals) | | |

^{a)}electrophoretic mobility μe ≦ −0.5 to −0.2 (μm/s)/(V/cm) at a pH of 3 to 7, determined using a Zetasizer ® 3000 from Malvern.

The clearcoat material 1 of inventive example 1 was clear and completely free of turbidity even after 24 hours of storage. Its flow viscosity at 23° C. in the DIN 4 flow cup remained constant at 16 seconds. It was outstandingly suitable for producing clearcoats. In contrast, the clearcoat material C1 of comparative example C1 was turbid after 24 hours storage and had gelled so severely that it was no longer possible to measure its flow viscosity; it was no longer suitable for use.

Inventive Examples 2 and 3

The Preparation of the Clearcoat Materials 2 and 3

The clearcoat materials 2 and 3 were prepared by mixing the constituents indicated in Table 2 and homogenizing the respective mixtures.

TABLE 2
The physical composition of the clearcoat materials 2 and 3

| | Parts by weight: | |
|---|---|---|
| | Example 2 | Example 3 |
| Constituent | (inventive) | (inventive) |
| Binder solution (A1) from preparation | 36.137 | 30.047 |
| Example 1 | | |
| Binder solution (A2) from preparation | 9.3 | 7.8 |
| Example 2 | | |
| Rheological aid (D) from preparation | 2.7 | 2.3 |
| Example 3 | | |
| TACT ® (commercial | 24.1 | 20.2 |
| tris(alkoxycarbonylamino)triazine from | | |
| Cytec) | | |
| Butyldiglycol acetate | 5.0 | 4.2 |
| Butylglycol acetate | 5.0 | 4.2 |
| Baysilon ® OL 44 (commercial leveling agent | 0.063 | 0.053 |
| based on a modified polysiloxane, from | | |
| Bayer AG) | | |
| Tinuvin ® 400 (commercial triazine-based | 1.1 | 0.9 |
| light stabilizer from Ciba Specialty | | |
| Chemicals) | | |
| Highlink ® OG 502-31 (dispersion of | 15.7 | 29.5 |
| unmodified silica nanoparticles, 30 percent in | | |
| isopropanol from Clariant) | | |
| Bis(1-octyloxy-2,2,6,6-tetramethyl-4- | 0.9 | 0.8 |
| piperidyl) sebacate (PKB_{b} >9.0, Tinuvin ® | | |
| 123 from Ciba Specialty Chemicals) | | |

The clearcoat materials 2 and 3 were stable on storage and showed no turbidity or rise in viscosity even after storage for several weeks. They were outstandingly suitable for producing clearcoats.

### Inventive Examples 4 and 5

The Production of the Multicoat Effect Paint Systems 4 and 5

For Example 4 the clearcoat material 2 of Example 2 was used.

For Example 5 the clearcoat material 3 of Example 3 was used.

To produce the multicoat paint systems of the invention, steel panels were coated in succession with an electrocoat, deposited cathodically and baked at 170° C. for 20 minutes, with a dry film thickness of 18 to 22 μm. Thereafter the steel panels were coated with a commercial two-component water-based surfacer from BASF Coatings AG. The resultant surfacer film was baked at 90° C. for 30 minutes to give a dry film thickness of 35 to 40 μm. Thereafter the commercial aqueous basecoat material “Starsilber” from BASF Coatings AG was applied with wet film thicknesses which gave, after curing, dry film thicknesses of 12 to 15 μm, after which the resultant aqueous basecoat films were flashed off at 80° C. for ten minutes. The clearcoat materials 2 and 3 were then applied pneumatically in one cross pass using a gravity-feed cup-type gun. The wet film thicknesses of the clearcoat films were adjusted so as to give, after curing, dry film thicknesses of in each case 40 to 45 μm. The aqueous basecoat films and the clearcoat films were cured at room temperature for 5 minutes, at 80° C. for 10 minutes, and finally at 140° C. for 20 minutes. This gave the multicoat paint systems 4 and 5.

Their micropenetration hardness was determined as the universal hardness at 25.6 mN using a Fischerscope 100V with diamond pyramid according to Vickers.

Their scratch resistance was assessed by means of the sand test (cf. German patent application DE 198 39 453 A1, page 9 lines 1 to 63), the brush test (cf. German patent application DE 198 39 453 A1, page 9 lines 17 to 63), and the Amtec-Kistler test, which is known in the art, using 1.5 g/l ultrafinely ground quartz Sikron SH 200 (cf. T. Klimmasch, T. Engbert, Technologietage, Cologne, DFO, Report volume 32, pages 59 to 66, 1997).

Their gloss (20°) was measured before and after mechanical exposure, to DIN 67530.

Their resistance to long-term moisture exposure was tested in the constant condensation climate (CCC) test at 100% relative humidity and 40° C. for 240 hours (cf. test procedure MKK0001A, edition A/05.14.1996, available from BASF Coatings AG). The evaluation was made one hour after the end of condensation exposure.

Their adhesive properties were determined before and after the CCC test by means of a cross-cut test with adhesive tape removal, to DIN ISO 2409.

The chemical resistance was determined using the BART (BASF acid resistance test). In this test the multicoat paint systems 4 and 5 were exposed to temperature loads in a gradient oven (30 min, 50° C., 60° C. and 70° C. and 80° C.). Beforehand the test substances (1%, 10%, and 36% sulfuric acid; 5% sulphurous acid, 10% hydrofluoric acid, 5% sodium hydroxide solution, 1,2,3 and 4 drops of deionized water) were applied in a defined manner using a volumetric pipette. Following exposure to the substances, the substances were removed under running water and the damage was assessed visually after 24 h in accordance with a predetermined scale:

| Rating | Appearance |
|---|---|
| 0 | No defect |
| 1 | slight marking |
| 2 | marking/dulling/no softening |
| 3 | marking/dulling/color change/softening |
| 4 | cracks/incipient etching |
| 5 | clearcoat removed |

Each individual mark (spot) was evaluated and the result was stated as the ratings total for one temperature.

The results are given in Table 3.

TABLE 3
Hardness, scratch resistance, condensation resistance, and acid
resistance of the multicoat paint systems 4 and 5

| | Examples: | |
|---|---|---|
| | 1 | 2 |
| Test Method | inventive | inventive |
| Micropenetration hardness (N/mm²) | 98.9 | 107.3 |
| Brush Test: | | |
| Gloss before mechanical exposure | 85.2 | 80.3 |
| Gloss difference after mechanical exposure | 2.3 | 1.1 |
| Gloss difference after reflow (2 h/40° C.) | −0.7 | 0.9 |
| Gloss difference after reflow (2 h/80° C.) | −0.8 | 1.0 |
| Sand Test: | | |
| Gloss before mechanical exposure | 85.2 | 80.3 |
| Gloss difference after mechanical exposure | 9 | 11.2 |
| Gloss difference after reflow (2 h/40° C.) | 6.6 | 9.7 |
| Gloss difference after reflow (2 h/80° C.) | 7.2 | 8.9 |
| Amtec Test: | | |
| Gloss before mechanical exposure | 85.2 | 80.3 |
| Gloss difference after mechanical exposure | 24 | 21 |
| CCC: | | |
| Adhesion as per cross-cut testing before CCC | GT1 | GT1 |
| Blisters m/g 1 h after CCC | m0/g0 | m0/g0 |
| Adhesion as per cross-cut testing 1 h after CCC | GT0.5 | GT0.5 |
| Adhesion as per cross-cut testing | GT0.5 | GT0.5 |
| 24 h after CCC | | |
| BART: | | |
| Ratings total 50° C. | 6 | 4 |
| Ratings total 60° C. | 8 | 6 |
| Ratings total 70° C. | 16 | 4 |
| Ratings total 80° C. | 15 | 15 |

The results in Table 3 underlined the outstanding hardness, scratch resistance, adhesion, condensation resistance, acid resistance and reflow characteristics of the multicoat paint systems 4 and 5.

1. A curable composition comprising:
(A) at least one constituent curable physically or thermally and/or with actinic radiation,
(B) at least one kind of inorganic nanoparticles having an electrophoretic mobility μe≦−0.5 (μm/s)/(V/cm) at a pH of 3 to 7, and
(C) at least one light stabilizer based on sterically hindered amines (HALS) having a pK_{b} of at least 9.0.

2. A curable composition as claimed in claim 1, comprising at least two constituents (A) curable thermally and/or with actinic radiation.

3. A curable composition as claimed in claim 1, wherein the inorganic nanoparticles (B) are hydrophilic.

4. A curable composition as claimed in claim 1, wherein the inorganic nanoparticles (B) have an electrophoretic mobility μe<−1 (μm/s)/(V/cm) at a pH of 6 to 10.

5. A curable composition as claimed in claim 1, wherein the light stabilizer (C) has a pK_{b} of at least 9.5.

6. A curable composition as claimed in claim 1, wherein the light stabilizer (C) is selected from the group of the aminoether-functionalized HALS.

7. A curable composition as claimed in claim 1, comprising at least one additive (D).

8. A process of preparing a curable composition as claimed in claim 1 comprising mixing and homogenizing its constituents, which comprises
(1) determining the electrophoretic mobility le of inorganic nanoparticles and selecting therefrom at least one kind of inorganic nanoparticles (B) having an electrophoretic mobility μe≦−0.5 (μm/s)/(V/cm) at a pH of 3 to 7, and
(2) mixing the selected nanoparticles (B) with at least one light stabilizer (C) based on sterically hindered amines (HALS) having a pK_{b} of at least 9.0 and at least one constituent (A) curable thermally and/or with actinic radiation.

9. A cured composition as claimed in claim 1 comprising at least one of scratch-resistant, self-supporting films or moldings, coating materials, adhesives, sealants for producing scratch-resistant coatings, adhesive films and seals.

10. The cured composition as claimed in claim 9, wherein the coatings are clearcoats.

11. The secured composition as claimed in claim 10, wherein the clearcoats are an integral constituent of multicoat color and/or effect paint systems.
